(19) United States
(12) Patent Application Publication
(10) Pub. No.: US 2010/0171326 A1
(43) Pub. Date: Jul. 8, 2010

(54) LOCKABLE HANDLE ASSEMBLY

(76) Inventor: Bruce C. Bacon, Rockford, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/649,385

(22) Filed: Dec. 30, 2009

Related U.S. Application Data
(60) Provisional application No. 61/203,906, filed on Dec. 30, 2008.

(51) Int. Cl. E05B 3/00

(52) U.S. Cl. 292/336.3

(57) ABSTRACT

A lockable handle assembly has a base mounted stationary in an associated closure with a laterally extending lock bolt slot. A handle is rotatably mounted in the base, and is operably connected with an associated door latch. A lock cylinder is rotatably mounted in the handle for selective rotation between locked and unlocked positions. A lock cam is rotatably mounted in the handle, is operably connected with the lock cylinder, and has an arcuate cam surface. A rigid lock bolt is slidably mounted in the handle and is configured such that rotation of the lock cylinder between the locked and unlocked positions laterally shifts the lock bolt into and out of the lock bolt slot in the base to selectively prevent and permit rotation of the handle and unlatching of the closure.

### CLAIM OF PRIORITY

Applicant hereby claims the priority benefits under the provisions of 35 U.S.C. §120, basing said claim of priority on related provisional U.S. patent application Ser. No. 61/203,906, filed Dec. 30, 2008.

### BACKGROUND OF THE INVENTION

The present invention relates to latches for closures, such as doors and the like, and in particular to a lockable handle assembly for use in conjunction with recreational vehicle closures, such as pickup truck covers, RV storage compartments, and other similar applications.

Combination handle lock assemblies for recreational vehicles, such as those disclosed in U.S. Pat. No. 6,685,240, are generally well known in the art. However, such prior art handle lock assemblies are relatively difficult to install in an associated recreational vehicle closure, thereby resulting in relatively high assembly costs. Also, prior handle lock assemblies have a relatively bulky, thick design, which cannot be used on thin doors or closures. Furthermore, most prior handle lock assemblies can be operated either only manually or only through a remote actuated power unit. Hence, a lockable handle assembly which overcomes these drawbacks would clearly be advantageous.

### SUMMARY OF THE INVENTION

One aspect of the present invention is a lockable handle assembly for closures and the like, having a base adapted for stationary mounting on an associated closure, and having a central mounting aperture and a laterally extending lock bolt slot. An exterior handle is rotatably mounted in the central aperture of the base, has a central mounting aperture, and is operably connected with an associated door latch, such that rotation of the exterior handle unlatches the door latch to permit opening the closure from an exterior side of the closure. A lock cylinder is rotatably mounted in an outer portion of the central mounting aperture of the exterior handle for selective rotation between locked and unlocked positions. A lock cam is rotatably mounted in an inner portion of the central mounting aperture of the exterior handle, has an arcuate cam surface, and is operably connected with the lock cylinder, such that rotation of the lock cylinder between the locked and unlocked positions selectively rotates the cam surface between locked and unlocked positions. A rigid lock bolt is slidably mounted in the exterior handle for selective engagement by the cam surface on the lock cam, whereby rotation of the lock cylinder between the locked and unlocked positions laterally shifts the lock bolt into and out of the lock bolt slot in the base to selectively prevent and permit rotation of the exterior handle and unlatching of the closure.

Another aspect of the present invention is a lockable handle assembly which is relatively easy to install in an associated recreational vehicle closure, thereby reducing overall cost.

Yet another aspect of the present invention is a lockable handle assembly which has a relatively compact and low profile design, which can be installed in even thin doors and other similar closures.

Yet another aspect of the present invention is a lockable handle assembly which can be operated manually, or can be easily converted for remotely actuated power operations.

Yet another aspect of the present invention is a lockable handle assembly that has a relative uncomplicated design that is efficient in use, economical to manufacture, capable of a long operating life, and particularly well adapted for the proposed use.

These and other advantages of the invention will be further understood and appreciated by those skilled in the art by reference to the following written specification, claims and appended drawings.

### BRIEF DESCRIPTION OF THE DRAWINGS

FIG. 1 is an exploded perspective view of a lockable handle assembly embodying the present invention, taken from a forward portion thereof.

FIG. 1A is a perspective view of the lockable handle assembly, taken from a rearward portion thereof.

FIG. 2 is an exploded perspective view of the lockable handle assembly, taken from a rearward portion thereof.

FIG. 3 is an exploded perspective view of the lockable handle assembly, taken from a side portion thereof.

FIG. 4 is another exploded perspective view of the lockable handle assembly, taken from a rearward portion thereof.

FIG. 5 is a rear elevational view of the lockable handle assembly, shown in a locked position.

FIG. 5A is another rear elevational view of the lockable handle assembly, shown in the unlocked position.

FIG. 6 is an exploded perspective view of another embodiment of the present invention.

FIG. 6A is an elevational view of a lock positioner portion of the lockable handle assembly.

FIG. 6B is a perspective view of the lock positioner shown in FIG. 6A.

FIG. 7 is a rear elevational view of the lockable handle assembly illustrated in FIG. 6, shown in a locked position.

FIG. 7A is another rear elevational view of the lockable handle assembly illustrated in FIG. 6, shown in the unlocked position.

FIGS. 8-10 are exploded perspective views of yet another embodiment of the present invention.

### DETAILED DESCRIPTION OF THE PREFERRED EMBODIMENTS

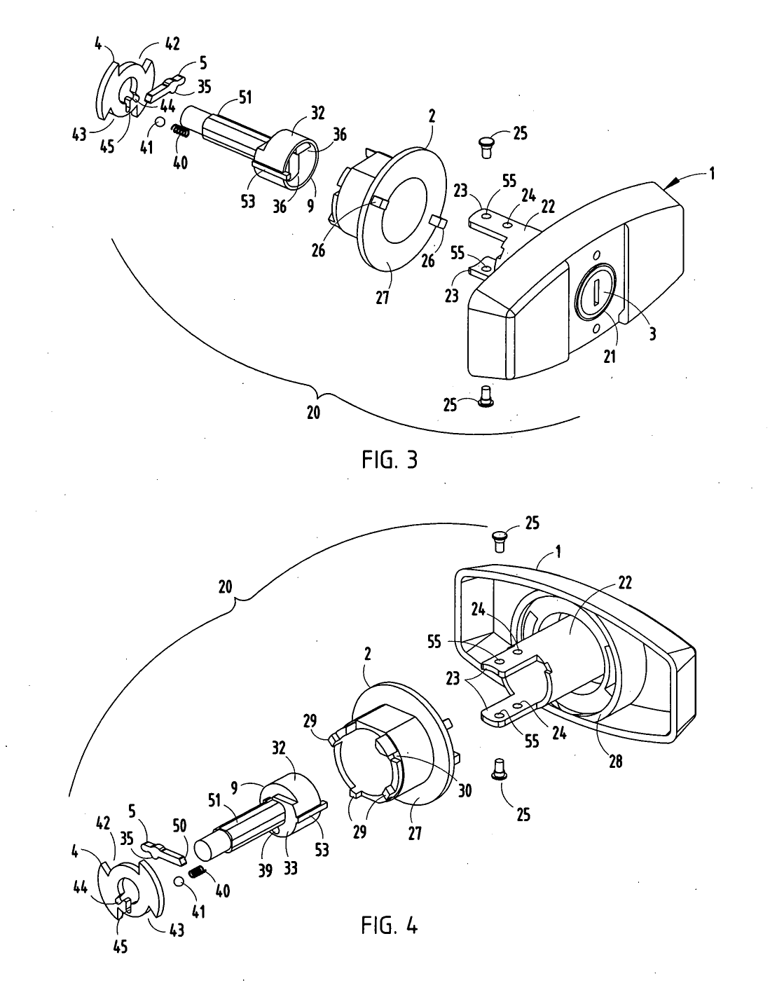

For purposes of description herein, the terms “upper”, “lower”, “right”, “left”, “rear”, “front”, “vertical”, “horizontal” and derivatives thereof shall relate to the invention as oriented in FIG. 3. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

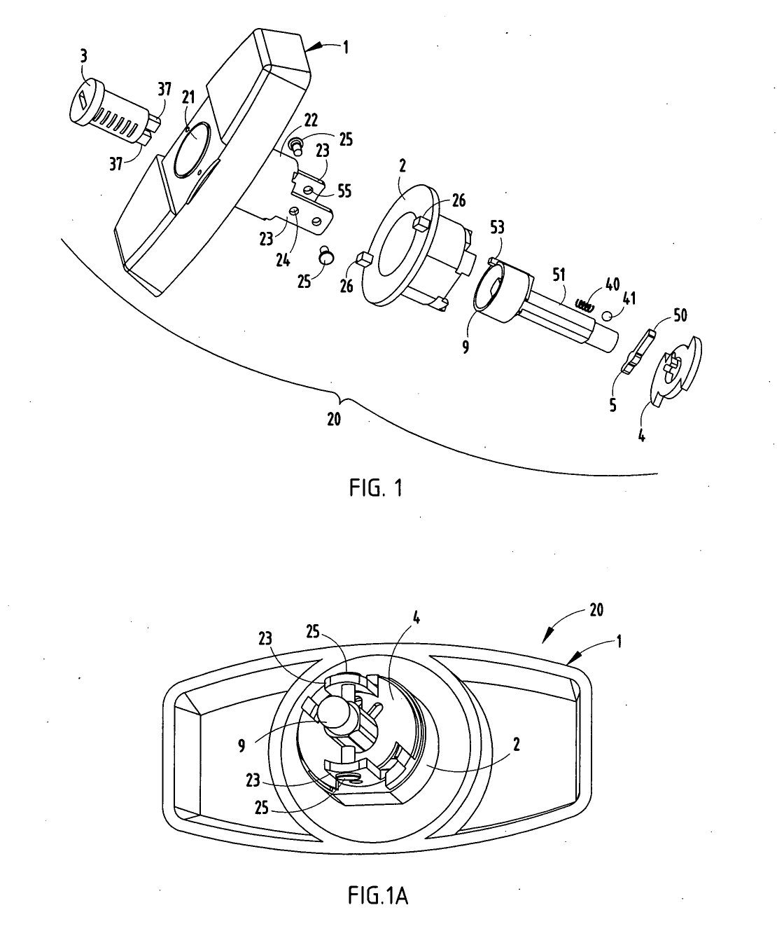

With reference to FIG. 1, the illustrated lockable handle assembly 20 includes an annularly-shaped base 2 fixedly mounted on a door or closure, and an exterior handle 1 that is rotatably mounted in base 2. Handle 1 has an elongated shape that is configured for grasping to axially rotate handle 1 relative to base 2 and the associated closure or door. Handle 1 also includes a central aperture 21 with an exterior portion in which an associated lock cylinder 3 is rotatably mounted. Handle 1 also includes a cylindrical barrel portion 22 with a pair of axially extending fingers or prongs 23, each of which includes radially extending apertures 24, which serve to receive pins 25 that retain the various parts of the lockable handle assembly 20 together in the manner shown in FIG. 1A.

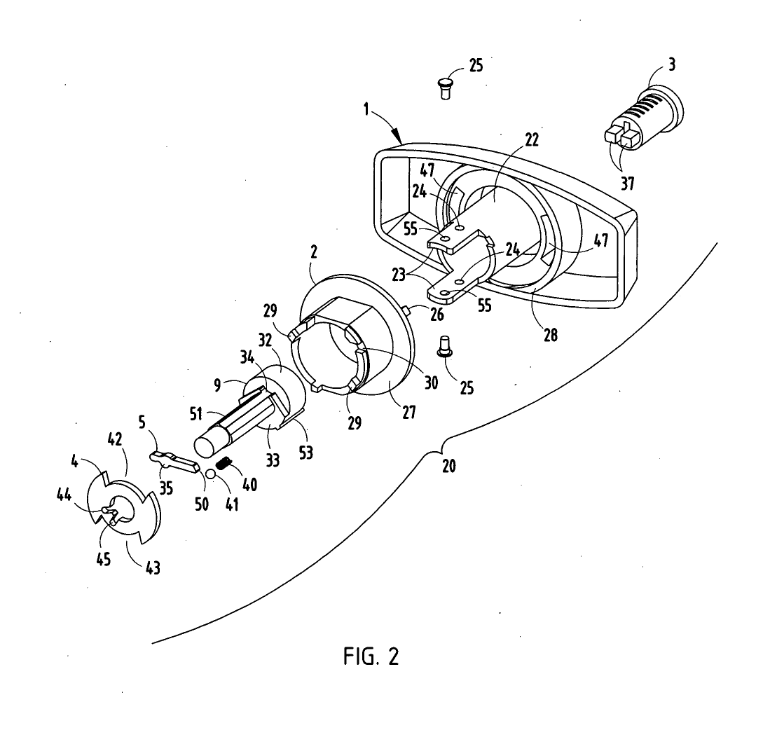

Base 2 includes a pair of axially extending stops 26 on the outer end thereof, which selectively engage handle 1 to limit the rotation thereof in the manner described below. As best illustrated in FIG. 2, base 2 also includes a circularly-shaped flange 27 at the outer end thereof, which is closely received within a mating recess 28 on the interior of handle 1, and acts as a guide when handle 1 is rotated between latched and unlatched positions. The interior end of base 2 includes a plurality of axially, inwardly protruding stops 29 that interface with an associated stationary lock positioner 4, as well as a generally lateral or radial lock bolt slot 30 that interfaces with a lock bolt 5, as described in greater detail hereinafter. A pin-shaped, rotating lock cam 9 includes a cylindrically-shaped head 32 at the outward end thereof, which extends into an interior portion of the central aperture in base 2, and is telescopingly received within the interior of the barrel portion 22 of handle 1. A wedge-shaped cam 33 is formed on and rotates with head 32, and includes an arcuate center portion 34, in which the bulbous portion 35 of a rigid lock bolt 5 is received to lock and unlock handle 1 in the manner described below.

With reference to FIG. 3, the exterior end face of the head portion 32 of rotating lock cam 9 includes a pair of recesses or grooves 36 into which a pair of inwardly extending tongs 37 (FIG. 1) on lock cylinder 3 are received, such that when lock cylinder 3 is permitted to rotate relative to handle 1 by virtue of inserting the correct key, rotation of lock cylinder 3 also selectively rotates rotating lock cam 9. It is noteworthy that the lock cylinder tongs 37 ride in the lock cam grooves 36 to provide an indirect connection therebetween in which lock cylinder 3 is permitted to rotate relative to lock cam 9 between the locked and neutral positions, and between the unlocked and neutral positions, as explained in greater detail below. As best illustrated in FIG. 4, the axial inward face of the head portion 32 of rotating lock cam 9 also includes an axially extending, eccentrically disposed aperture 39 in which a coil spring 40 is received. A positioner ball 41 is supported on the free or inward end of coil spring 40, and interfaces with stationary lock positioner 4 in the manner described below to assist in selectively locating lock cylinder 3 in either the fully locked position or fully unlocked position relative to base 2. As best illustrated in FIG. 2, stationary lock positioner 4 is generally in the form of a circular disk, which includes top and bottom peripheral cutouts 42 and 43, through which the prongs 23 on handle 1 extend, as shown in FIG. 1A. The stops 26 on base 2 engage mating arcuate slots 47 (FIG. 2) in the interior of handle 1 which limit rotation of handle 1 between the latched and unlatched positions. Stationary lock positioner 4 also includes a pair of radially extending internal slots 44 and 45, which selectively receive therein the ball 41 supported on coil spring 40 in rotating lock cam 9 to selectively retain rotating lock cam 9 in the fully locked and fully unlocked positions, as described below.

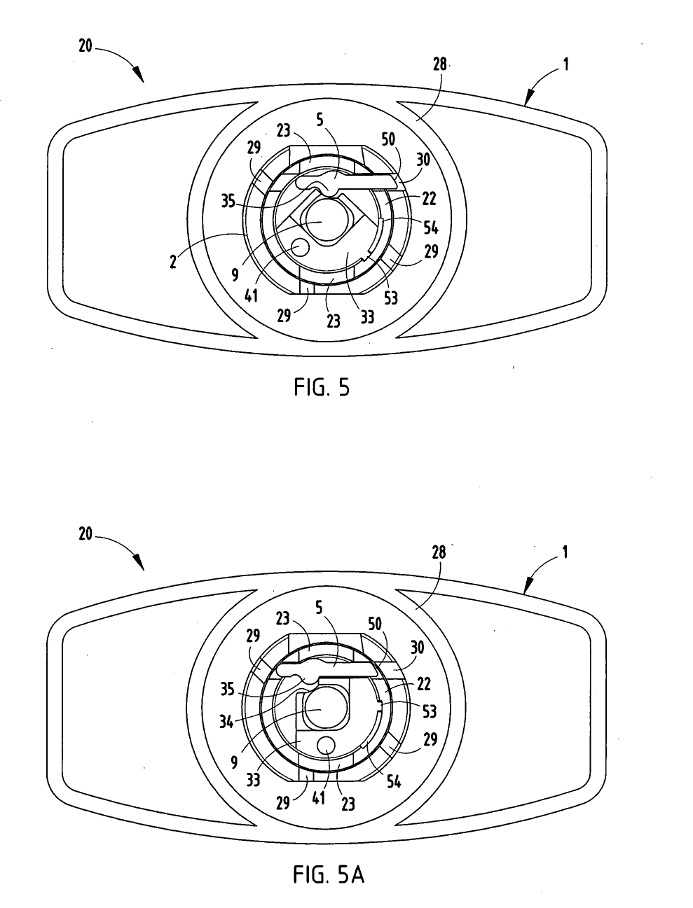

With reference to FIG. 3, the head portion 32 of rotating lock cam 9 has an axially outwardly protruding finger 53 that projects radially outwardly of head 32 and selectively rotates in a slot 54 (FIGS. 5-5A) in the interior face of handle 1. In FIG. 5, finger 53 is shown abutting one end of slot 54, and in FIG. 5A, finger 53 is shown abutting the opposite end of slot 54. The interaction of finger 53 in slot 54 rotationally interconnects handle 1 with rotating lock cam 9 in a uniquely selective manner which permits the handle assembly 20 to be operated from outside the vehicle through rotation of handle 1, or operated from inside the vehicle by rotation of rotary lock cam 9.

With reference to FIGS. 5-5A, the lockable handle assembly 20 operates in the following manner. FIG. 5 illustrates the lockable handle assembly 20 in the normally fully locked position, wherein lock bolt 5 is received in the lock bolt slot 30 of base 2, such that handle 1 cannot be rotated. Ball 41 is shown in the slot 44 of stationary lock positioner 4 to selectively retain rotary lock cam 9 in the fully locked position. To shift lock bolt 5 to the fully unlocked position and permit manual rotation of handle 1, an appropriate key is inserted into a key slot of lock cylinder 3, and lock cylinder 3 is then rotated in a clockwise direction (to the left) relative to handle 1 from the neutral position to the fully unlocked position. Rotation of lock cylinder 3 rotates rotating lock cam 9 relative to base 2 and stationary lock positioner 4, such that the arcuate portion 34 of cam 33 engages the bulbous portion 35 of lock bolt 5 and shifts the lock bolt 5 laterally or radially inwardly to disengage the free end 50 of lock bolt 5 from the associated lock bolt slot 30 in base 2, as shown in FIG. 5A. Rotation of rotating lock cam 9 also shifts ball 41 out of slot 44 in stationary lock positioner 4 from the locked position shown in FIG. 5, to the unlocked position shown in FIG. 5A, wherein ball 41 is shifted into detent or slot 45 in stationary lock positioner 4, such that rotating lock cam 9 cannot be inadvertently shifted out of the fully unlocked position. With lock bolt 5 in the retracted, unlocked position, lock cylinder 3 is then rotated back to the neutral position, where the key can be removed from lock cylinder 3. The indirect rotational interconnection between lock cylinder tongs 37 and lock cam grooves 36, in conjunction with the interface between positioner ball 41 and lock positioner slot 44, permits lock cylinder 3 to be rotated from the unlocked position to the neutral position without shifting rotating lock cam 9 from the fully unlocked position. Handle 1 can then be rotated to mechanically shift remotely located rotary latches (not shown) to unlock the recreational vehicle closure in a conventional fashion. For example, in the above-noted U.S. Pat. No. 6,685,240, the interior ends of the cables 100 attached to rotary latches 98 would be connected with the outer set of apertures 55 on handle prongs 23, so that rotation of handle 1 tensions cables 100 and releases latches 98, so that the cover 90 can be raised to the open position.

To lock lockable handle assembly 20, the key is inserted into the key slot of lock cylinder 3, and lock cylinder 3 is then rotated in a counterclockwise direction (to the right) relative to handle 1 from the neutral position to the fully locked position. Rotation of lock cylinder 3 also rotates rotating lock cam 9 relative to base 2 and stationary lock positioner 4, such that the arcuate portion 34 of cam 33 engages the bulbous portion 35 of lock bolt 5 and shifts the lock bolt 5 laterally or radially outwardly to engage the free end 50 of lock bolt 5 in the lock bolt slot 30 in base 2, as shown in FIG. 5. Rotation of rotating lock cam 9 also shifts ball 41 out of detent or slot 45 in stationary lock positioner 4 from the unlocked position shown in FIG. 5A, to the locked position shown in FIG. 5, wherein ball 41 is shifted into detent or slot 44 in stationary cam positioner 4, such that rotating lock cam 9 cannot be inadvertently shifted out of the fully locked position. Lock cylinder 3 is then rotated back to the neutral position, where the key can be removed from lock cylinder 3. In this position, handle 1 cannot be rotated relative to base 2.

It is also possible to readily convert the subject handle/lock assembly 20 and a remotely controlled, power lock/unlock feature in the following manner. An electric solenoid, or other motor (not shown), is operably connected with the inward or spine-shaped end 51 of rotary lock cam 9, so as to pivot the same upon activation between the fully locked position and the fully unlocked position. In the manner described above, rotation of lock cam 9 by the motor (not shown) pivots the cam 33 on head 32, thereby shifting the lock bolt 5 between the fully locked position shown in FIG. 5 and the fully unlocked position shown in FIG. 5A.

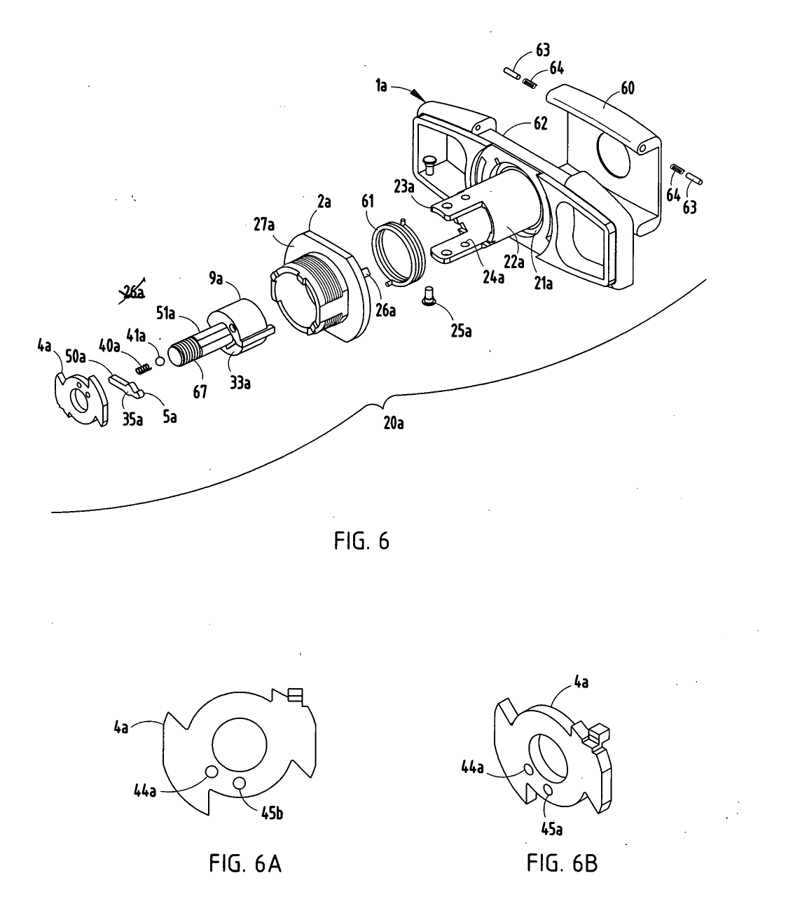

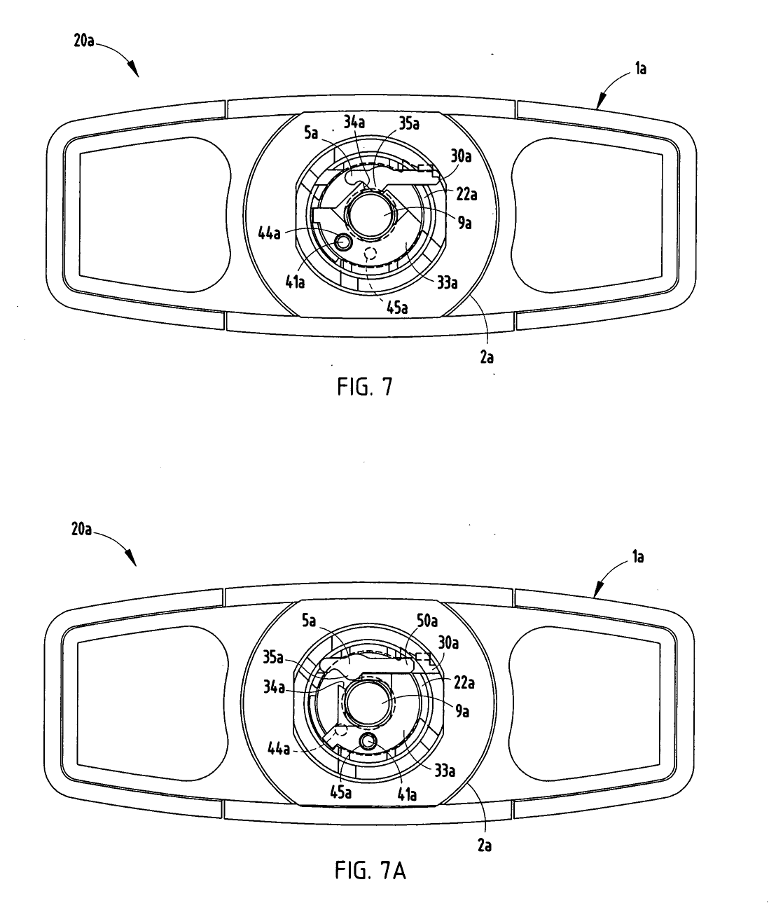

The reference numeral 20a (FIGS. 6-7A) generally designates another embodiment of the present invention having a flip cover 60 and a handle return spring 61. Since lockable handle assembly 20a is similar to the previously described lockable handle assembly 20, similar parts appearing in FIGS. 1-6A and FIGS. 7 and 8, respectively, are represented by the same, corresponding reference numerals, except for the suffix “a” in the numerals of the latter. The exterior handle 1a of lockable handle assembly 20a includes a centrally disposed vertically extending slot 62 in which flip cover 60 is pivotally mounted. A pair of hinge pins 63 support flip cover 60 for rotation along a generally vertical plane relative to handle 1a. A pair of coil springs 64 are mounted on hinge pins 63 and have opposite ends connected with flip cover 60 and handle 1a to bias flip cover 60 to a normally closed position overlying slot 62 and generally flush with the exterior surface of handle 1a. To access the lock cylinder, flip cover 60 is pivoted upwardly about hinge pins 63. In the closed position, flip cover 60 protects the lock cylinder from snow, ice and other outside elements.

In the example shown in FIGS. 6-6B, the ball detents 44a and 45a in stationary lock positioner 4a are in the form of circular through holes shaped to selectively receive positioner ball 41a therein. Also, the interior end 67 of rotating lock cam 9a is threaded to facilitate attachment of an interior cable actuator, handle or the like. Coil spring 61 has opposite ends thereof connected with handle 1a and base 2a and resiliently biases handle 1a to a central or latched position.

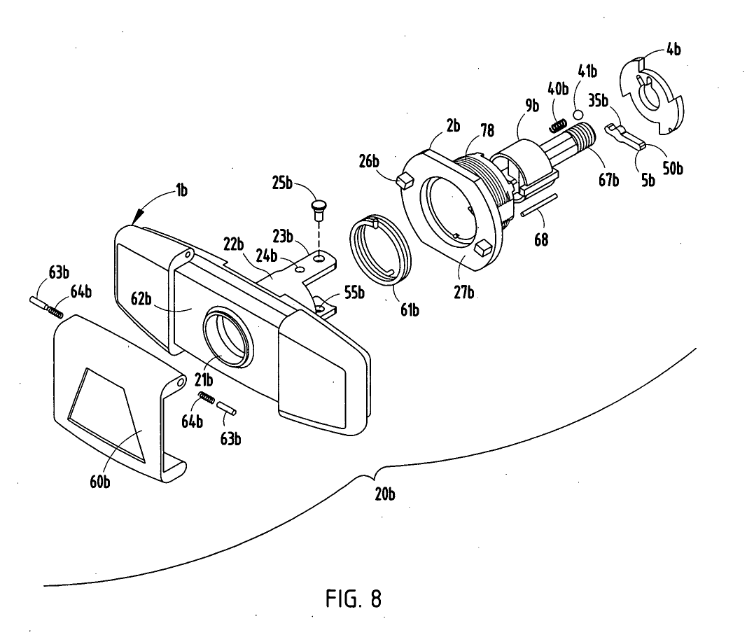

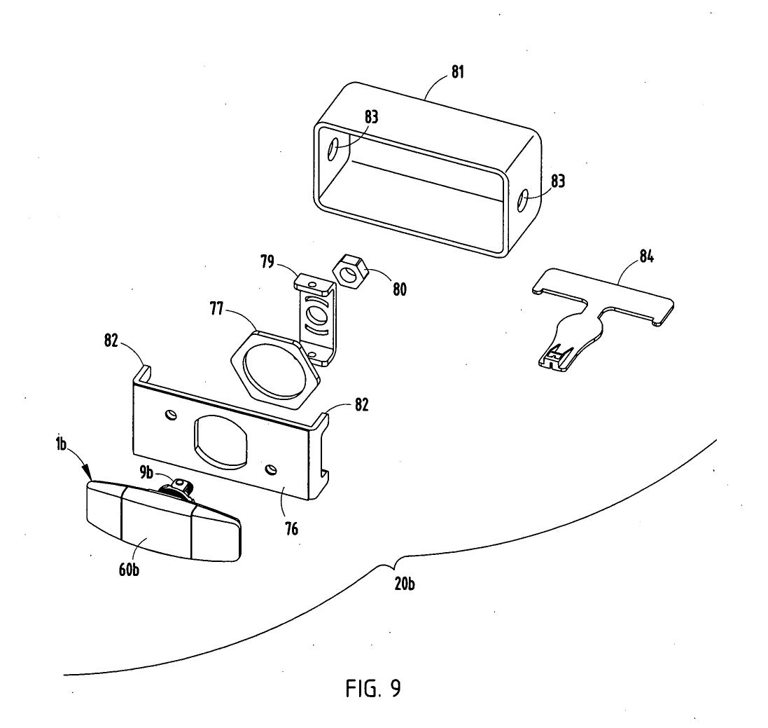

The reference numeral 20b (FIGS. 8-10) generally designates another embodiment of the present invention having both manual and remotely controlled electric actuator versions. Since lockable handle assembly 20b is similar to the previously described lockable handle assemblies 20 and 20a, similar parts appearing in FIGS. 1-5A, FIGS. 6-7A, and FIGS. 8-10, respectively, are represented by the same, corresponding reference numerals, except for the suffix “b” in the numerals of the latter.

The manually actuated lockable handle assembly 20b shown in FIGS. 8 and 9 is similar to lockable handle assembly 20a shown in FIGS. 6-7A insofar as it has a flip cover 60b which protects the lock cylinder 3b, such that insertion of key 75 into the associated keyway and rotation of the lock cylinder are made easier. In lockable handle assembly 20b, a metal reinforcing pin 68 is inserted through stationary lock positioner 4b into base 2b along the edge of the lock bolt slot to assist in guiding the lock bolt 5b and ensuring proper locking engagement between lock bolt 5b and the lock bolt slot. Lockable handle assembly 20b is mounted on a bracket 76 disposed fixedly in an associated door or closure by a threaded nut 77 which engages mating threads 78 on the exterior of base 2b. A cable attachment bracket 79 is mounted on the threaded end 67b of rotating lock cam 9b by a threaded nut 80. An interior cover 81 attaches to the inwardly angled sidewalls 82 of bracket 76 and encloses the interior portions of lockable handle assembly 20b, including cable bracket 79. Actuator cables (not shown) are threaded through side apertures 83 in cover 81 and are attached to the outer ends of cable bracket 79, such that rotation of rotary lock cam 9a rotates cable bracket 79 and tenses the cables to actuate the associated rotary latches or the like. An interior release handle 84 is positioned within the interior of the vehicle, and is operably connected with the actuator cables, such that pulling release handle 84 unlatches the door or closure to permit the same to be opened.

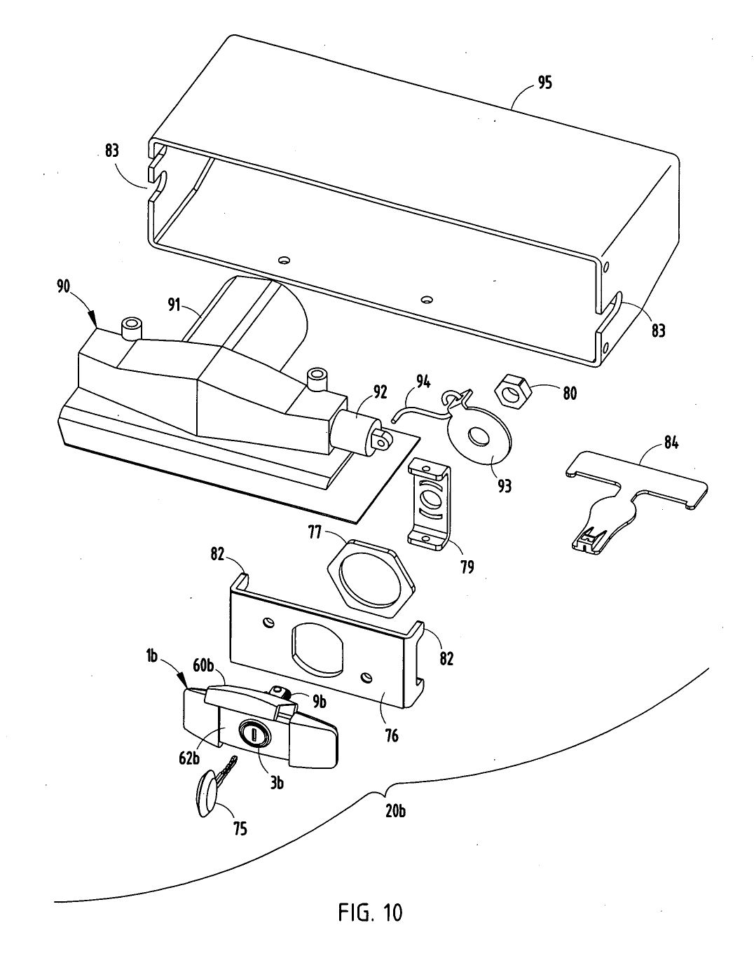

With reference to FIG. 10, lockable handle assembly 20b can be readily adapted to add a remotely controlled electric actuator 90 to shift the rotating lock cam between the locked and unlocked positions. The illustrated electric actuator 90 has a generally conventional construction, is typically mounted within the interior of the door or closure, and includes an electric ram or motor 91, which longitudinally reciprocates an actuator arm 92. A bell crank 93, in the form of an armed washer, is mounted on the interior end of the rotating lock cam 9b, and is positioned between cable bracket 79 and retainer nut 80, such that bell crank 93 rotates with rotating lock cam 9b. The outer end of actuator arm 92 is pivotally connected with an arm 94 on bell crank 93, such that when motor 91 is actuated by a remotely generated signal, actuator arm 92 extends or retracts, thereby pivoting rotating lock cam 9b from the interior end thereof between the locked and unlocked positions from an interior location in the vehicle. A large cover 95 is provided to enclose electric actuator 90, along with the interior portions of lockable handle assembly 20b. A key 75 may be used to manually lock and unlock lockable handle assembly 20b from the exterior of the vehicle, as described in detail above.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is as follows:

1. A lockable handle assembly for closures and the like, comprising:
a base adapted for stationary mounting on an associated closure, and having a central mounting aperture, and a generally laterally extending lock bolt slot;
an exterior handle rotatably mounted in said central aperture of said base, having a central mounting aperture, and being operably connected with an associated door latch, such that rotation of said exterior handle unlatches the door latch to permit opening the closure from an exterior side of the closure;
a lock cylinder rotatably mounted in an outer portion of said central mounting aperture of said exterior handle for selective rotation between locked and unlocked positions;
a lock cam rotatably mounted in an inner portion of said central mounting aperture of said exterior handle, having an arcuate cam surface, and being operably connected with said lock cylinder, such that rotation of said lock cylinder between said locked and unlocked positions selectively rotates said cam surface between locked and unlocked positions; and
a rigid lock bolt slidably mounted in said exterior handle for selective engagement by said cam surface on said lock cam, whereby rotation of said lock cylinder between said locked and unlocked positions laterally shifts said lock bolt into and out of said lock bolt slot in said base to selectively prevent and permit rotation of said exterior handle and unlatching of the closure.

2. A lockable handle assembly as set forth in claim 1, including:
a lock positioner mounted stationary relative to said base and having a first detent; and
a positioning element supported on said lock cam and axially shifting into and out of said first detent to selectively retain said lock cam in said locked position.

3. A lockable handle assembly as set forth in claim 1, wherein:
said lock positioner has a second detent; and
said positioning element shifts into and out of said second detent to selectively retain said lock cam in said unlocked position.

4. A lockable handle assembly as set forth in claim 3, wherein:
said lock cylinder comprises a portion of a key lock assembly, and includes a keyway, and a key selectively received in said keyway to permit rotating said lock cylinder between said locked and unlocked positions.

5. A lockable handle assembly as set forth in claim 4, wherein:
said lock cylinder includes a neutral position disposed rotationally centrally between said locked and unlocked positions wherein said key can be removed from said keyway;
and said lock cylinder is configured to prevent removal of said key from said keyway except when said lock cylinder is in said neutral position.

6. A lockable handle assembly as set forth in claim 5, wherein:
said lock cam includes a spine-shaped portion adapted for interconnection with an electric actuator for remotely shifting said lock cam into and out of said locked position.

7. A lockable handle assembly as set forth in claim 6, wherein:
said handle includes a barrel portion with at least one connector adapted for operative connection with an associated rotary latch.

8. A lockable handle assembly as set forth in claim 7, wherein:
said lock cam includes an integral, axially extending, arcuately-shaped cam surface disposed in a radially spaced relationship with the axis of rotation of said lock cam; and
said lock bolt includes a radially inwardly protruding bulbous portion which is selectively engaged by said cam surface of said cam lock during rotation of said cam lock to shift said lock bolt into and out of said lock bolt slot in said base.

9. A lockable handle assembly as set forth in claim 8, wherein:
said lock positioner includes an axially facing first ball detent defining said first detent;
said lock positioner includes an axially facing second ball detent defining said second detent; and
said positioning element comprises a ball and spring element which resiliently biases said ball axially outwardly into selective engagement with said first and second ball detents.

10. A lockable handle assembly as set forth in claim 9, including:
a flexible line having a first end thereof operably connected with said connector on said barrel portion of said handle such that rotation of said handle tenses said flexible line.

11. A lockable handle assembly as set forth in claim 10, including:
an interior release handle shaped for positioning on an interior side of the closure and operably connected with said flexible line such that actuation of said release handle unlatches the door latch.

12. A lockable handle assembly as set forth in claim 11, including:
a remotely controllable, linearly reciprocating electric actuator shaped for mounting on the closure and operably connected with said spine-shaped portion of said lock cam such that extension and retraction of said electric actuator shift said lock cam between the locked and unlocked positions.

13. A lockable handle assembly as set forth in claim 12, wherein:
said barrel portion of said handle includes a pair of axially extending prongs between which said lock cam and said lock positioner are received and retained.
